(19) United States
(12) Patent Application Publication
(10) Pub. No.: US 2019/0070998 A1
(43) Pub. Date: Mar. 7, 2019

(54) VEHICLE LIGHTING SYSTEMS AND METHODS

(71) Applicant: NEVER SECOND LLC, Farmington, UT (US)

(72) Inventors: Shane R. SPENCER, Harrisville, UT (US); DeOrr L. WIGHT, Farmington, UT (US)

(73) Assignee: NEVER SECOND LLC, Farmington, UT (US)

(21) Appl. No.: 16/119,783

(22) Filed: Aug. 31, 2018

Related U.S. Application Data
(60) Provisional application No. 62/553,695, filed on Sep. 1, 2017.

(51) Int. Cl. B60Q 1/04; B60Q 1/26; H05B 37/02

(52) U.S. Cl. CPC B60Q 1/0483; B60Q 1/2615; B60Y 2200/20; B60Y 2200/124; B60Y 2200/132; H05B 37/0263

(57) ABSTRACT

Systems and methods for vehicle auxiliary lighting. An auxiliary lighting system includes at least one light member, a bracket, and a controller. The bracket includes a base portion, and a plurality of connection members extending from the base portion in a first direction, the connection members configured to releasably connect the lighting system to a vehicle with a snap-fit connection. The bracket also includes a plurality of light attachment members extending from the base portion in a second direction, the at least one light member being releasably attached to the base portion with the plurality of light attachment members. The controller is operable to operate the at least one light members between an OFF state and at least one ON state.

### RELATED APPLICATION

This application claims the benefit of the filing date of U.S. Provisional Application No. 62/553,695, filed on 1 Sep. 2017, and entitled VEHICLE LIGHTING SYSTEMS AND METHODS, the disclosure of which is incorporated, in its entirety by this reference.

### TECHNICAL FIELD

The present disclosure is directed to auxiliary lighting systems for vehicles and related methods of mounting and/or operating auxiliary lighting systems for vehicles.

### BACKGROUND

The power sports industry has been increasing in popularity over the past several decades. Power sports vehicles such as all-terrain vehicles (ATVs), snowmobiles, motorcycles, utility task vehicles (UTVs—also known as side-by-side off-road vehicles, recreational off-highway vehicles (ROV), or multipurpose off-highway utility vehicle (MOHUV)), and the like have become increasingly complex with higher performance capabilities to meet the needs of a growing population of users that demand greater power, higher speeds, and advanced amenities to improve the off-road experience. It is common for many users to add auxiliary components and systems to their vehicles in order to improve aesthetics, performance, and/or change functionality. Some users prefer to add and/or replace various components and systems themselves rather than use professional services such as service departments at dealerships, or the like. Opportunities exist for improving the ease of installation, use and replacement of auxiliary and custom systems for power sports vehicles.

### SUMMARY

One aspect of the present disclosure relates to a lighting system having at least one light member, a bracket, and a controller. The bracket includes a base portion, and a plurality of connection members extending from the base portion in a first direction, the connection members configured to releasably connect the lighting system to a vehicle with a snap-fit connection. The bracket also includes a plurality of light attachment members extending from the base portion in a second direction, the at least one light member being releasably attached to the base portion with the plurality of light attachment members. The controller is operable to operate the at least one light members between an OFF state and at least one ON state.

The at least one light member may include an LED light. The at least one light member may include an halogen light. The at least one light member may include at least two light members. The at least one ON state may include a flashing light state and a constant beam state. The base portion may include a planar surface, and the at least one light member may be mounted to the planar surface. The plurality of light attachment members may include a plurality of pairs of light attachment members extending from the planar surface. The bracket may include a metal material, and the plurality of connection members and plurality of light attachment members may be formed from the metal material. The bracket may include a polymer material, and the plurality of connection members and plurality of light attachment members may be formed from the polymer material. The plurality of light attachment members may secure the at least one light member to the bracket base portion with an interference fit connection.

Another aspect of the present disclosure relates to a method of supplementing lighting on a vehicle. The method includes providing an auxiliary lighting system having at least one light member and a bracket, the bracket having a base portion, a plurality of connection members extending from the base portion in a first direction, and a plurality of light attachment members extending from the base portion in a second direction. The method also includes releasably mounting the at least one light member to the base portion with the plurality of light attachment members, releasably mounting the bracket to the vehicle with the plurality of connection members, and electrically connecting the at least one light member to a power source of the vehicle.

The auxiliary lighting system may further include a controller, and the method may further include operating the controller to control the at least one light members between an OFF state and at least one ON state. The plurality of connection members may provide a snap-fit connection of the bracket to the vehicle. The bracket may be configured to releasably mount to a headlight housing or a tail light housing of the vehicle. The method may also include operating the at least one light member to generate at least one of white light and amber light.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, including their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components, including those having a dash and a second reference label, apply to other similar components. If only the first reference label is used in the specification, the description is applicable to any one of the similar components having the same first reference label irrespective of the second reference label.

FIG. 1A is a front perspective view of a vehicle light with an auxiliary lighting system mounted thereto.

FIG. 1B is a cross-sectional view of the auxiliary lighting system and vehicle light shown in FIG. 1A taken along cross-section indicators 1B-1B.

FIG. 2 is an exploded perspective view of the vehicle light and auxiliary lighting system show in FIG. 1A.

FIG. 3 is a front perspective view of the auxiliary lighting system shown in FIG. 1A.

FIG. 4 is a rear perspective view of a bracket of the auxiliary lighting system shown in FIGS. 1-3.

FIG. 5 is a rear plan view of the bracket shown in FIG. 4.

FIG. 6 is a rear plan view of another embodiment of a bracket for an auxiliary lighting system according to the present disclosure.

FIG. 7 is a schematic circuit diagram for the auxiliary lighting systems disclosed herein.

FIG. 8 shows one embodiment of a system in accordance with various aspects of this disclosure.

FIG. 9 is a flow chart illustrating an example of a method in accordance with various aspects of this disclosure.

### DETAILED DESCRIPTION

The following relates generally to vehicle lighting systems, and particularly relates to auxiliary lighting systems for vehicles. The following also relates generally to methods of mounting lighting systems to vehicles, and particularly auxiliary lighting systems, and methods of operating such lighting systems, replacing such lighting systems, and other related methods. An auxiliary lighting system may generally refer to a lighting system that is used in addition to or supplements an existing lighting system, such as one or more light fixtures of a vehicle. An existing lighting system for a vehicle may include, for example, headlights, taillights, turn signal lights, flood lights, fog lights, and the like. An auxiliary lighting system may be mounted to the vehicle adjacent to one or more existing light fixtures of the vehicle. Alternatively, an auxiliary lighting system may include one or more additional light fixtures positioned at other locations on the vehicle that are spaced remote from the existing light fixtures of the vehicle.

Some existing auxiliary lighting systems for vehicles are difficult and time consuming to add to a vehicle. The time-intensive, sometimes complex process of adding the auxiliary lighting system to the vehicle may discourage users from purchasing an auxiliary lighting system, or to mount the auxiliary lighting system to the vehicle themselves rather than paying for the services of a professional to mount the auxiliary lighting system. The lighting systems of the present disclosure provide a cost-effective, easy to mount and dismount lighting system for vehicles that address many of the shortcomings of existing auxiliary lighting systems.

In at least one embodiment, the lighting systems disclosed herein may mount to the vehicle with a snap-fit connection. The snap-fit connection may be formed between a bracket of the auxiliary lighting system and a housing or frame piece of the vehicle such as, for example, a housing member of an existing light fixture of the vehicle. Such a snap-fit connection may provide easy mounting and dismounting of the auxiliary lighting system while still ensuring a secure connection to the vehicle. The wiring for the auxiliary lighting system may be connected to a power source of the vehicle. The auxiliary lighting system may include a controller such as an ON/OFF switch or other control mechanism that operates one or more light members of the lighting system between ON and OFF states or between various ON states (e.g., constant ON, flashing, strobe, dimming, etc.). The controller may include a processor and/or computing device, and may be programmable to perform certain functions.

The lighting systems disclosed herein may also relate to other types of attachment mechanisms besides a snap-fit connection. For example, an interference fit connection, brackets, fasteners, adhesives, welding, and the like may be used to mount the auxiliary lighting system to the vehicle. Some types of connection arrangements may make it possible to disconnect the lighting system from the vehicle, whereas other types of attachment arrangements may provide for a permanent connection (e.g., a permanent connection typically resulting in damage to or failure of the device if attempted to be separated).

The auxiliary lighting systems disclosed herein may include a bracket or frame portion that substantially matches the shape and/or size of one or more features of the vehicle. In one example, the bracket or frame of the auxiliary lighting system matches the profile or perimeter shape of a light fixture or other component of the vehicle, such as a bezel or housing portion of a headlight or taillight of the vehicle. The matching shape of the bracket or frame of the auxiliary lighting system may help avoid blocking the light projected from the existing vehicle light fixture, may provide an aesthetically pleasing appearance, and/or make it possible to fit the auxiliary lighting system within an existing cavity, recess or other area that provides concealing, protection, or access for the auxiliary lighting system.

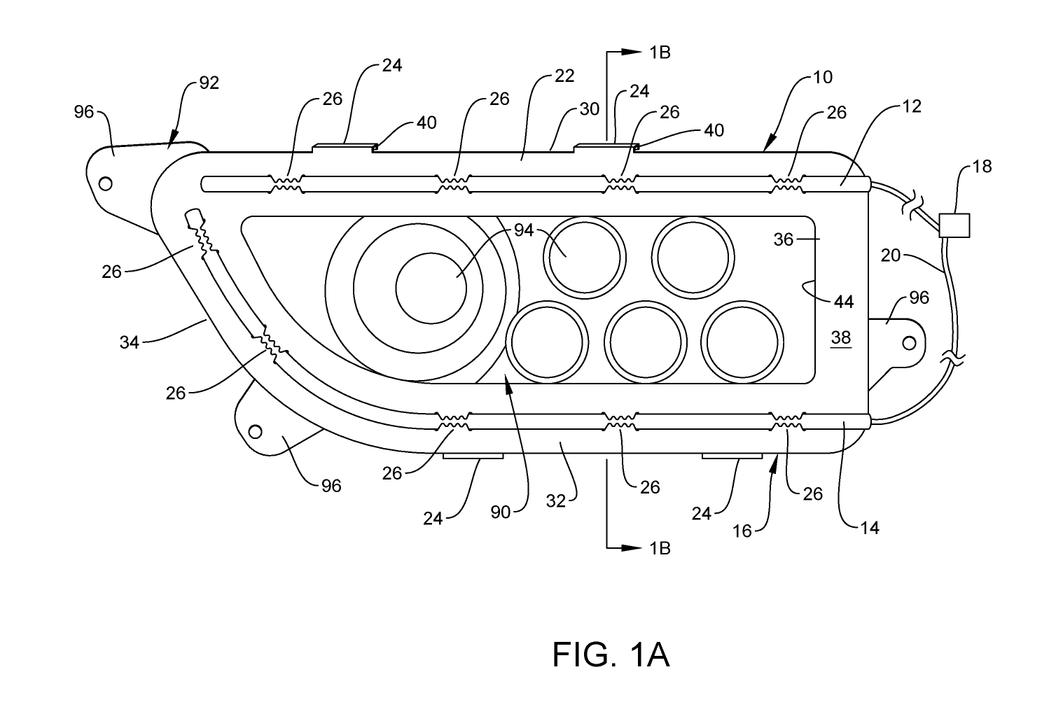

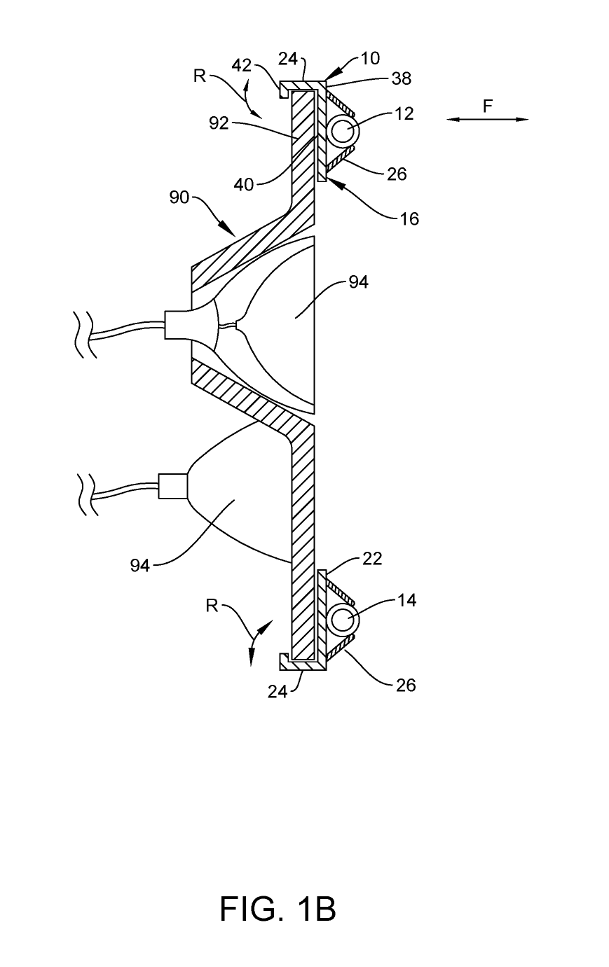

Referring to FIGS. 1A and 1B, a lighting system 10 in accordance with the present disclosure is shown mounted to a vehicle light assembly 90. The lighting system 10 includes first and second light members 12, 14, a bracket 16, and a controller 18. The bracket 16 defines an interior window 44 through which a plurality of light members 94 of the vehicle light assembly 90 are visible. The first and second light members 12, 14 are positioned vertically above, vertically below, and/or on one or more sides of the light members 94. The light members 12, 14 may provide light in addition to the light generated by the light members 94. In some embodiments, the light members 12, 14 may be operable independent of the light members 94 such that the light members 12, 14 can turn ON and OFF at different times and used independent of the ON/OFF operation of the light members 94.

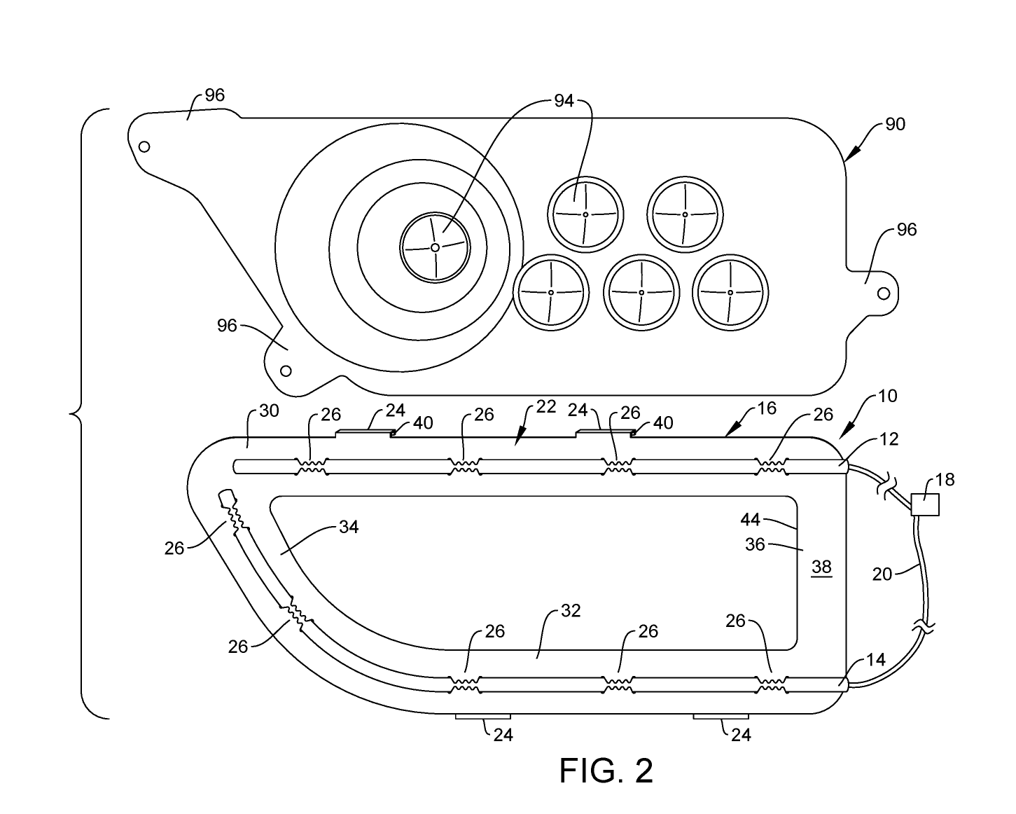

Referring to FIG. 2, the vehicle light assembly 90 also includes a light housing 92. The bracket 16 of the lighting system 10 may be configured to releasably mount to the light housing 92. As discussed above, a variety of mounting features may be used to provide a connection between the bracket 16 (or lighting system 10 generally) and the light housing 92 or other feature of the vehicle which possesses the vehicle light assembly 90.

The first and second light members 12, 14 are connected to the controller 18 with wiring 20. The controller 18 may be positioned at any location such as, for example, on a dashboard, within a cab, on a steering column, on handle bars, or at another location on the vehicle that typically is accessible to the driver of the vehicle when the driver is in a position to operate the vehicle.

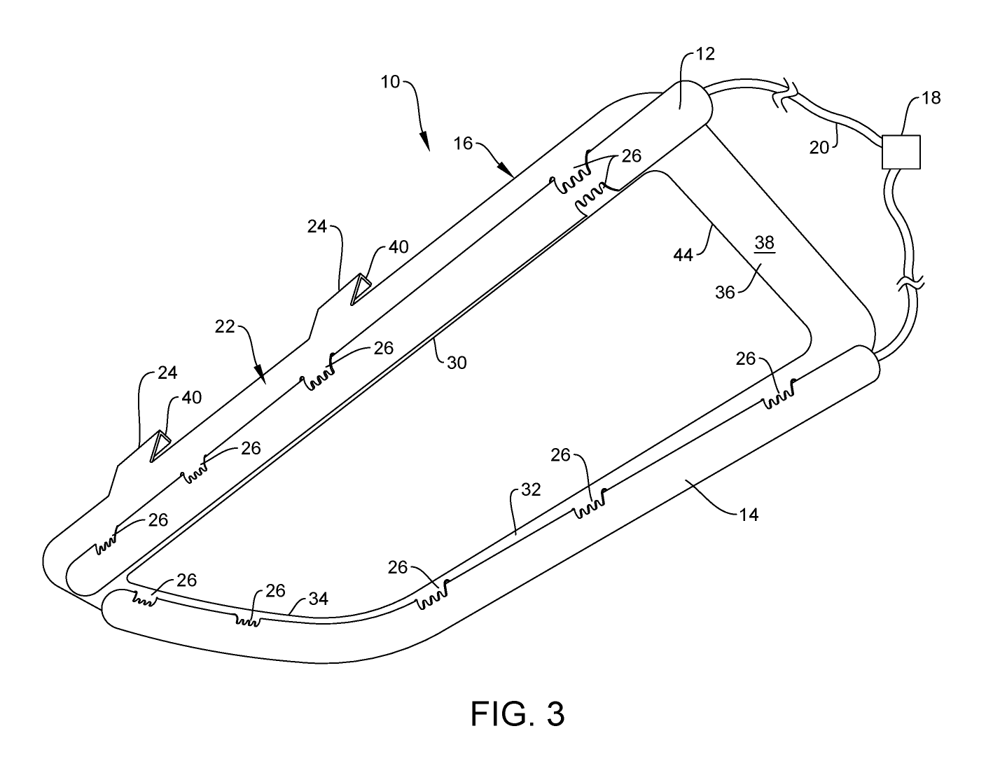

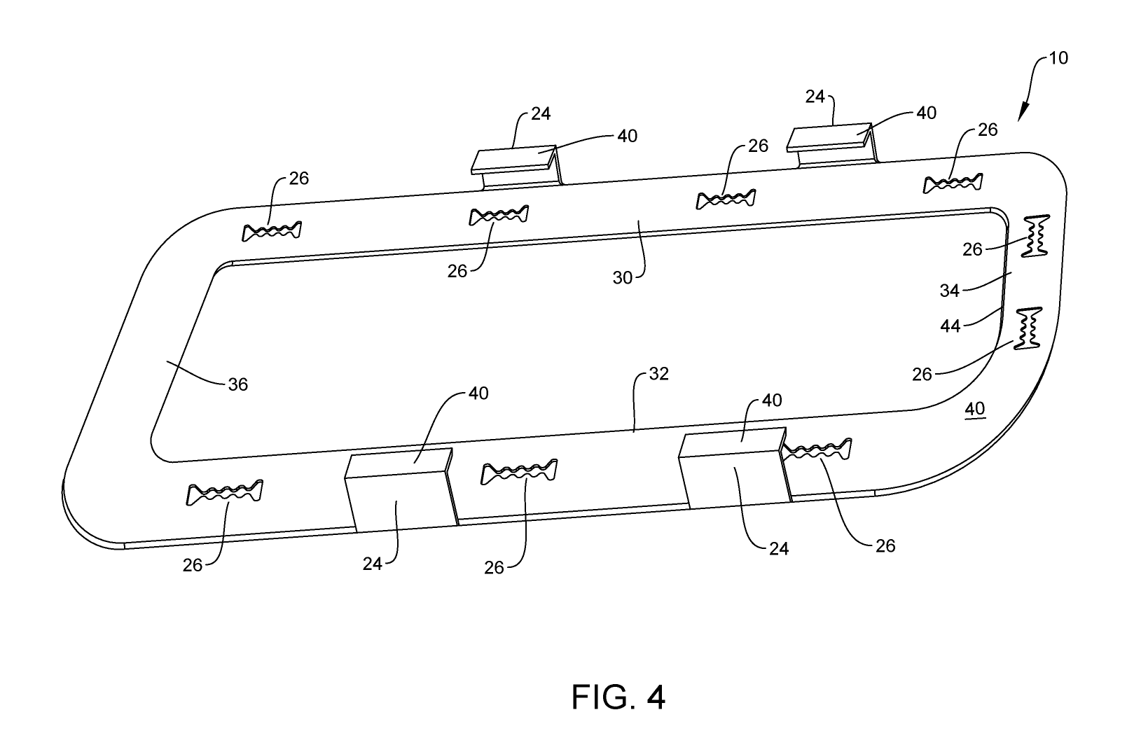

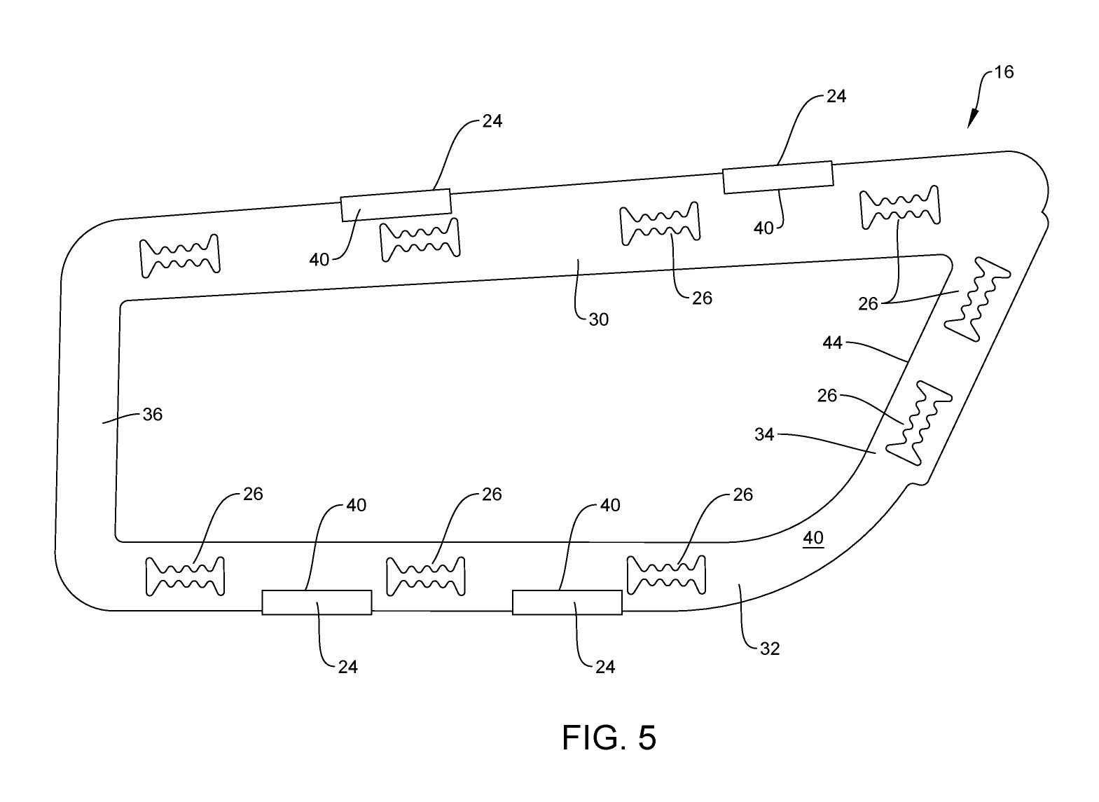

The bracket 16 includes a base portion 22, connection members 24, and light attachment members 26. The base portion 22 may include top and bottom portions 30, 32, first and second end portions 34, 36, and front and rear surfaces 38, 40. The front and rear surfaces 38, 40 are shown in the various front and rear views of FIGS. 1-5. The connection members 24 extend from the base portion 22, such as from the rear surface 40. The light attachment members 26 may extend from the base portion 22 such as from the front surface 34. The connection members 24 may include release tabs 42 (see FIGS. 1B and 3-5). The connection members 24 may be configured to releasably connect the bracket 16 to the light housing 92. The release tabs 42 may elastically deform to provide the releasable connection such as by rotating in the direction R as shown in FIG. 1B. Applying a force in the direction F as shown in FIG. 1B may deform the release tabs 42 of the connection members 24 to either secure the bracket 16 to the light housing 92 or release the bracket 16 from that light housing 92. The connection members 24 may be positioned along the top and bottom portions 30, 32, as shown in the figures. Alternatively, the connection members 24 may be positioned along the first and second end portions 34, 36, or on a combination of any of the portions 30, 32, 34, 36. In some embodiments, the connection members 24 may be separately formed and secured to the base portion 22 in a separate assembly step. In other embodiments, the connection members 24 may be formed integrally as a single piece with the base portion 22.

The light attachment members 26 may operate to releasably connect the first and second light members 12, 14 to the bracket 16. The light attachment members 26 may be formed in pairs arranged opposite each other so as to be positioned on opposite sides of the light members 12, 14. In some embodiments, the light members 12, 14 may rest upon the front surface 38 of the bracket 16 when the light attachment members 26 apply a securing or mounting force that holds the light members 12, 14 against the front surface 38. Other embodiments are possible in which separate brackets or other securing features are mounted to the bracket 16 in a separate assembly step, and these light attachment features separately attach to the light members 12, 14.

The light attachment members 26 and connection members 24 may be integrally formed as a single piece with the remaining portions of bracket 16. In some embodiments, the bracket 16 may be formed from a single piece of sheet metal (e.g., aluminum) using a forming method such as stamping or bending. Alternatively, the bracket 16 may be formed using molding, casting, 3D printing, or any other variety of forming or fabricating techniques. The bracket 16 may comprise, for example, a metal material, a polymer material, a fibrous material, fiberglass, composites or the like. The bracket 16 may be formed using conductive materials, insulative materials, heat-resistant materials, or other materials that are selected for any of a variety of properties as desired for any particular lighting system application. The bracket 16 may have any desired color, such as a color that matches the color of the existing lighting fixtures, housings, bezels, or other features of the vehicle. Alternatively, the bracket 16 may be formed from a material or coated with a material that accentuates or complements, for example, the color of lights generated by the first and second light members 12, 14, or the light members 94 of the vehicle. In one example, one or both of the light members 12, 14 may generate a yellow or amber colored light, and the light members 12, 14 may be operated by the controller 18 to a flashing ON state that functions as a blinker for the vehicle. In some embodiments, the light members 12, 14 may be able to generate a plurality of different light colors so as to increase the number of functions possible for the lighting system 10.

The first and second light members 12, 14 may comprise light emitting diodes (LEDs), halogen lights, and neon lights, and other lights commonly used on off-road vehicles such as the Polaris RZR®, Kawasaki TERYX®, and Honda Pioneer®. The light members 12, 14 may be shaped to match a portion of an outer profile of the vehicle light assembly 90, such as the light housing 92 or light members 94. For example, the second light member 14 is shown in at least FIG. 1A extending along end portion 34 and bottom portion 32, whereas the first lighting member 12 extends only along the top portion 30, and neither of the light members 12, 14 extend along the second end portion 36. Other embodiments may provide for a single light member that extends along all of the top, bottom, and first and second side portions 30, 32, 34, 36, or one or more of the portions 30, 32, 34, 36. Some light members may include one or more contoured portions (e.g., light member 14) whereas other light members may include only a linear shape. One or more of the light members 12, 14 may be sized and shaped to match a size and/or shape of the bracket 16.

The first and second light members 12, 14 are shown in at least FIG. 1A extending along the base portion 22 of the bracket 16 at a midpoint between an outer edge of the base portion 22 and the interior window 44. Other embodiments may provide positioning of the light members 12, 14 along the outer edge or along the edge of the interior window 44, or at any other desired location on the base portion 22. In some embodiments, the light members 12, 14 may have a sufficient width to substantially cover the base portion 22 or one or more of the portions 30, 32, 34, 36. In other embodiments, the light members 12, 14, rather than having the generally elongate shapes shown in FIG. 1A, may have other shapes such as circular or rectangular, and/or may include an assembly of lights arranged in a pattern or in series, or other configurations.

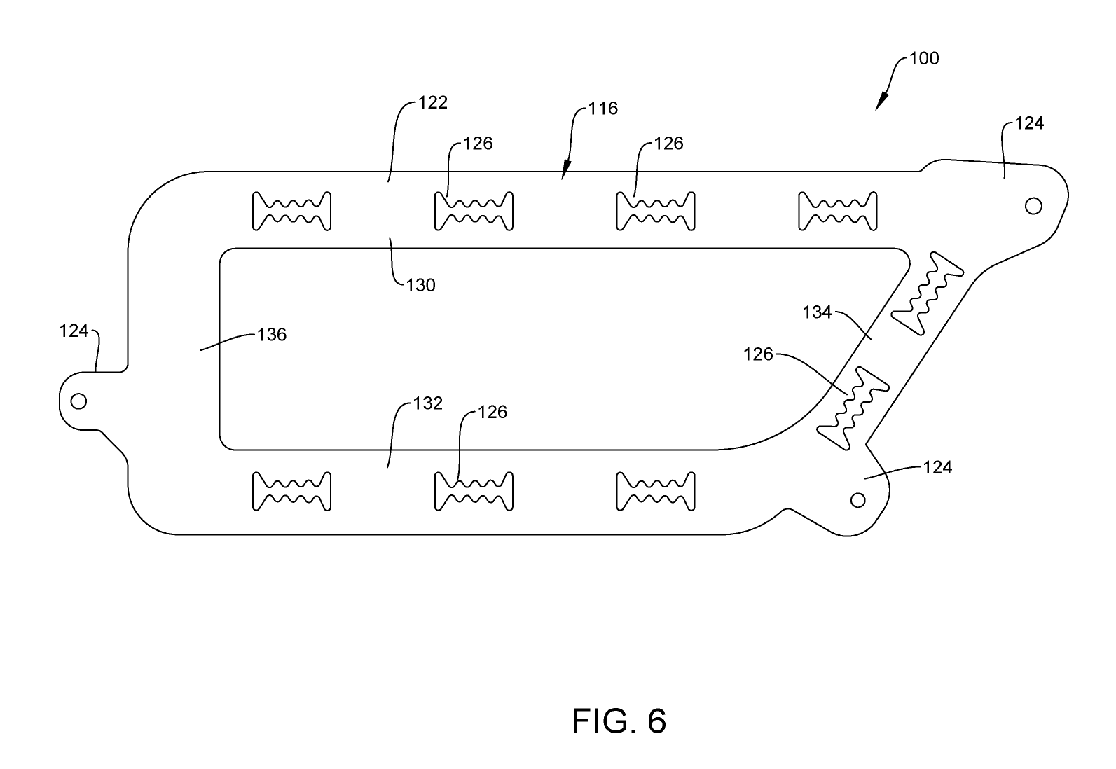

Referring to FIG. 6, another embodiment of the lighting system 100 is shown. The lighting system 100 includes a plurality of connection members 124 positioned around a periphery of a base portion 122 of a bracket 116. The connection members 124 may be sized and arranged to substantially match with a plurality of mounting brackets 96 of the light housing 92 of the vehicle light assembly 90 (see arrangement of mounting brackets 96 in FIG. 1). The bracket 116 may also include a plurality of light attachment members 126 to help secure one or more light members (e.g., light members 12, 14) to the bracket 116. Fasteners may be used to secure the connection members 124 to the vehicle, such as to the light housing 92, or directly to other features of the vehicle such as a frame, bezel, or the like.

Many other types of attachment features besides those shown in FIGS. 1-6 may be used to secure a lighting system in accordance with the present disclosure to the vehicle. The embodiments of FIGS. 1-6 may be particularly useful for releasably mounting an auxiliary lighting system to the vehicle in a way that is relatively efficient and user-friendly from a cost, time and complexity perspective.

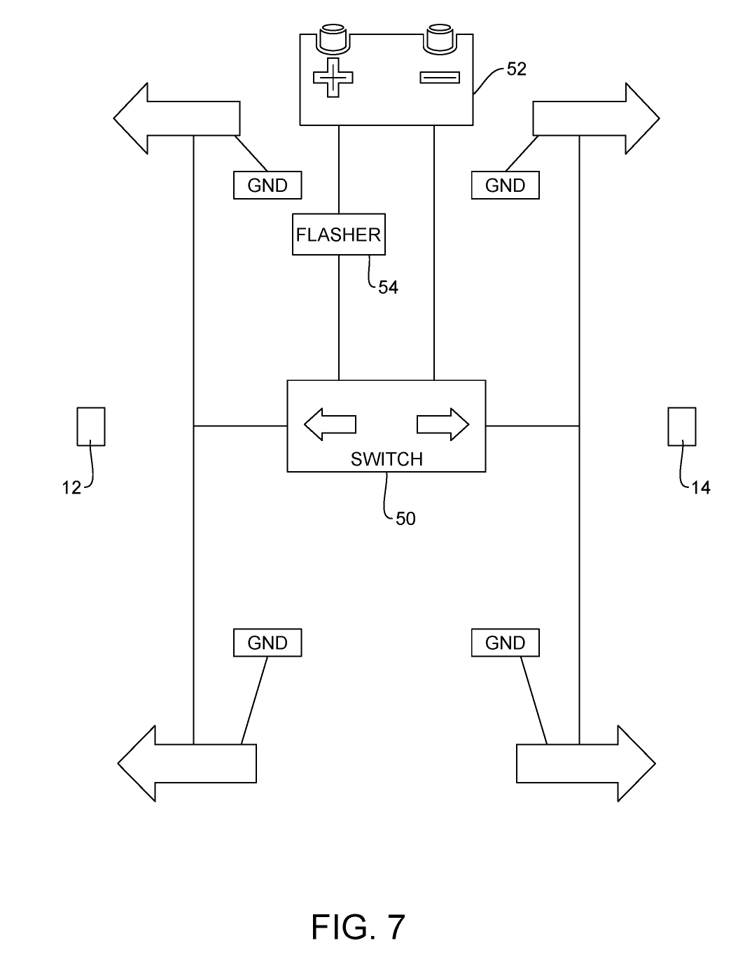

FIG. 7 illustrates schematically a circuit or power control in a lighting system in accordance with the present disclosure. The circuit shown in FIG. 7 includes a switch 50, a power supply or source 52, and a flasher mechanism 54. The power supply 52 may be part of the vehicle power supply. Alternatively, the auxiliary lighting system may include its own independent power source. In some embodiments, the vehicle engine may power or charge the independent power source of the auxiliary lighting system. The switch 50 may be operable by a user manually to turn ON and OFF one or more light members 12, 14. In some embodiments, the lighting system may be programmed via controller 18 or other processor, computer or control device of the vehicle or lighting system to operate automatically based on predetermined conditions. For example, the light members 12, 14 of the auxiliary lighting system 10 may be turned ON automatically under certain light conditions while the vehicle is operating, may turn ON or OFF automatically when certain existing lights of the vehicle are turned ON or OFF, or may dim to a certain light output based on operation of various light fixtures of the vehicle or other conditions. Operation and control of the auxiliary lighting systems disclosed herein should not be limited to the examples disclosed. Further, the schematic circuit diagram shown in FIG. 7 can be made much more complex or even more simple depending on the desired functionality for the auxiliary lighting system.

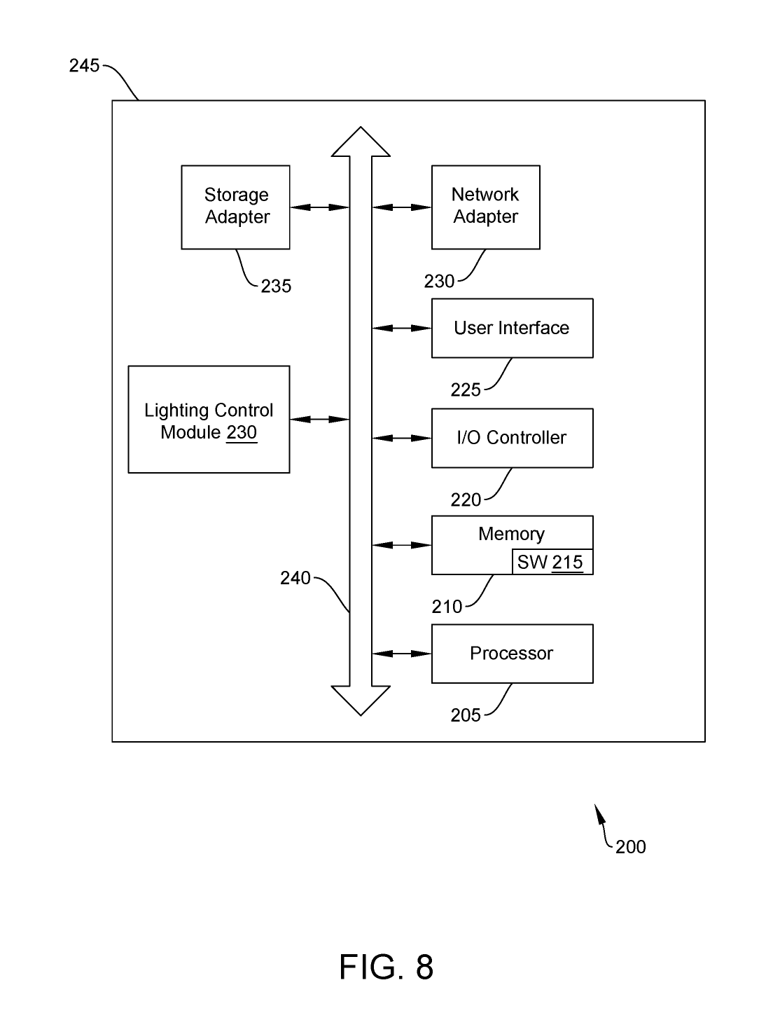

FIG. 8 shows a system 200 for control of vehicle auxiliary lighting, in accordance with various examples. System 200 may include an apparatus 245, which may be an example of any one of devices of systems 10, 100 of FIGS. 1-6, or any components or portions of systems 10, 100 disclosed herein.

Apparatus 245 may include components for bi-directional communications including components for transmitting communications and components for receiving communications. For example, apparatus 245 may communicate bi-directionally with one or more computing devices of a vehicle to which the auxiliary lighting system is mounted. This bi-directional communication may be direct (apparatus 245 communicating directly with a computing system, for example) and/or indirect (apparatus 245 communicating indirectly with a computing system through another device or system, for example).

Apparatus 245 may also include a processor module 205, and memory 210 (including software/firmware code (SW) 215), an input/output controller module 220, a user interface module 225, a network adapter 230, and a storage adapter 235. Apparatus 245 may include one or more processors. The software/firmware code 215 may be one example of a software application executing on apparatus 245. The network adapter 230 may communicate bi-directionally, via one or more wired links and/or wireless links, with one or more networks. In some embodiments, network adapter 230 of apparatus 245 may provide a connection using wireless techniques, including digital cellular telephone connection, Cellular Digital Packet Data (CDPD) connection, digital satellite data connection, and/or another connection. The network adapter 230 may enable one or more of WWAN (GSM, CDMA, and WCDMA), WLAN (including BLUETOOTH® and Wi-Fi), WMAN (WiMAX) for mobile communications, antennas for Wireless Personal Area Network (WPAN) applications (including RFID and UWB), or any combination thereof.

One or more buses 240 may allow data communication between one or more elements of apparatus 245 such as processor module 205, memory 210, I/O controller module 220, user interface module 225, network adapter 230, and storage adapter 235, or any combination thereof. One or more of the components of the apparatus 245, individually or collectively, may be implemented using one or more application-specific integrated circuits (ASICs) adapted to perform some or all of the applicable functions in hardware. Alternatively, the functions may be performed by one or more other processing units (or cores), on one or more integrated circuits. The functions of each module may also be implemented, in whole or in part, with instructions embodied in memory formatted to be executed by one or more general and/or application-specific processors.

The memory 210 may include random access memory (RAM), read only memory (ROM), flash memory, and/or other types. The memory 210 may store computer-readable, computer-executable software/firmware code 215 including instructions that, when executed, cause the processor module 205 to perform various functions described in this disclosure. Alternatively, the software/firmware code 215 may not be directly executable by the processor module 205 but may cause a computer (when compiled and executed, for example) to perform functions described herein. Alternatively, the computer-readable, computer-executable software/firmware code 215 may not be directly executable by the processor module 205, but may be configured to cause a computer, when compiled and executed, to perform functions described herein. The processor module 205 may include an intelligent hardware device, for example, a central processing unit (CPU), a microcontroller, an application-specific integrated circuit (ASIC), field programmable gate array (FPGA), or any combination thereof.

In some embodiments, the memory 210 may contain, among other things, the Basic Input-Output system (BIOS) which may control basic hardware and/or software operation such as the interaction with peripheral components or devices. For example, at least a portion of the lighting module 230 to implement the present systems and methods may be stored within the system memory 210. Applications resident with system 200 are generally stored on and accessed via a non-transitory computer readable medium, such as a hard disk drive or other storage medium. Additionally, applications can be in the form of electronic signals modulated in accordance with the application and data communication technology when accessed via a network interface such as network adapter 230.

Many other devices and/or subsystems may be connected to and/or included as one or more elements of system 200 (for example, a personal computing device, mobile computing device, smart phone, server, internet-connected device, cell radio module, or any combination thereof). In some embodiments, all of the elements shown in FIG. 8 need not be present to practice the present systems and methods. The devices and subsystems can be interconnected in different ways from that shown in FIG. 8. In some embodiments, an aspect of some operation of a system, such as that shown in FIG. 8, may be readily known in the art and are not discussed in detail in this application. Code to implement the present disclosure can be stored in a non-transitory computer-readable medium such as one or more of system memory 210 or other memory. The operating system provided on I/O controller module 220 may be a mobile device operation system, a desktop/laptop operating system, a server operating system, or another known operating system.

The I/O controller module 220 may operate in conjunction with network adapter 230 and/or storage adapter 235. The network adapter 230 may enable apparatus 245 with the ability to communicate with devices such as devices of system 10 of FIGS. 1-5, and/or other devices over a communication network. Network adapter 230 may provide wired and/or wireless network connections. Storage adapter 235 may enable apparatus 245 to access one or more data storage devices such as storage device 110. The one or more data storage devices may include two or more data tiers each.

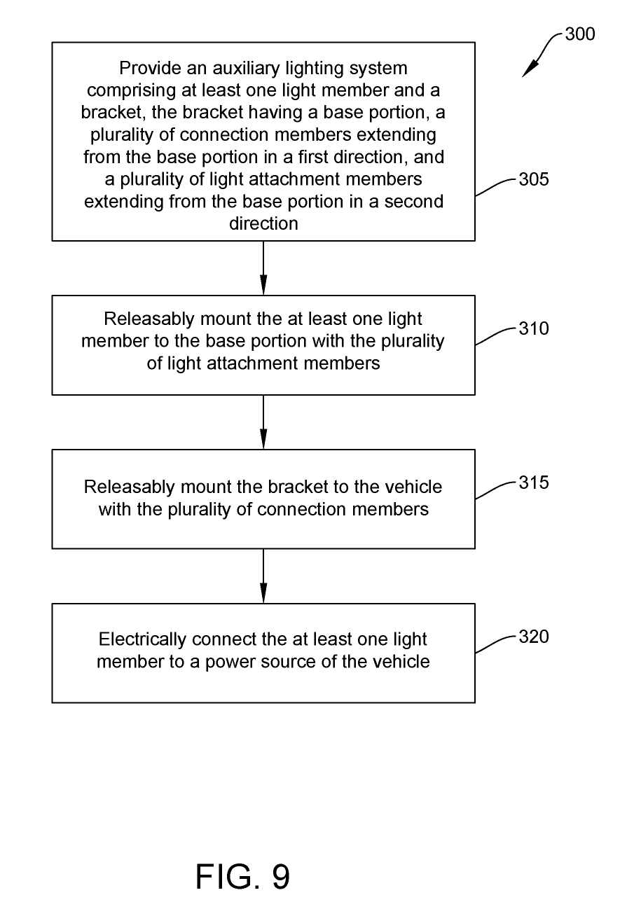

FIG. 9 is a flow chart illustrating an example of a method 300 for operating an auxiliary lighting system for a vehicle, in accordance with various aspects of the present disclosure. One or more aspects of the method 300 may be implemented in conjunction with the devices of systems 10, 100 of FIGS. 1-7, apparatus 245 of FIG. 8, and/or lighting module 230 depicted in FIG. 8. In some examples, a computing device and/or storage device may execute one or more sets of code to control the functional elements of the computing device and/or storage device to perform one or more of the functions described below. Additionally or alternatively, the computing device and/or storage device may perform one or more of the functions described below using special purpose hardware.

At block 305, the method 300 may include providing an auxiliary lighting system that includes at least one light member and a bracket, the bracket having a base portion, a plurality of connection members extending from the base portion in a first direction, and a plurality of light attachment members extending from the base portion in a second direction. At block 310, the method 300 may include releasably mounting the at least one light member to the base portion with the plurality of light attachment members. Block 315 may include releasably mounting the bracket to the vehicle with the plurality of connection members. Block 320 may include electrically connecting the at least one light member to a power source of the vehicle. Alternatively, the light members may be electrically connected to an auxiliary power source.

The method 300 may include other steps and functionality including, for example, providing a controller and operating a controller to control the at least one light member between OFF and ON states. The plurality of connection members may provide a snap-fit connection of the bracket to the vehicle. The bracket may be configured to releasably mount to a headlight housing or a taillight housing of the vehicle, or other light fixture of the vehicle.

It should be noted that the method 300 is just one implementation and that the operations of the method 300 may be rearranged, omitted, and/or otherwise modified such that other implementations are possible and contemplated. In some examples, aspects from two or more of the method 300 may be combined and/or separated. It should be noted that the method 300 are just example implementations, and that the operations of method 300 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC, or A and B and C.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A lighting system comprising:
at least one light member;
a bracket, comprising:
a base portion;
a plurality of connection members extending from the base portion in a first direction, the connection members configured to releasably connect the lighting system to a vehicle with a snap-fit connection;
a plurality of light attachment members extending from the base portion in a second direction, the at least one light member being releasably attached to the base portion with the plurality of light attachment members;
a controller operable to operate the at least one light members between an OFF state and at least one ON state.

2. The lighting system of claim 1, wherein the at least one light member includes an LED light.

3. The lighting system of claim 1, wherein the at least one light member includes a halogen light.

4. The lighting system of claim 1, wherein the at least one light member includes at least two light members.

5. The lighting system of claim 1, wherein the at least one ON state includes a flashing light state and a constant beam state.

6. The lighting system of claim 1, wherein the base portion includes a planar surface, and the at least one light member is mounted to the planar surface.

7. The lighting system of claim 6, wherein the plurality of light attachment members includes a plurality of pairs of light attachment members extending from the planar surface.

8. The lighting system of claim 1, wherein the bracket comprises a metal material, and the plurality of connection members and plurality of light attachment members are formed from the metal material.

9. The lighting system of claim 6, wherein the bracket comprises a polymer material, and the plurality of connection members and plurality of light attachment members are formed from the polymer material.

10. The lighting system of claim 6, wherein the plurality of light attachment members secures the at least one light member to the bracket base portion with an interference fit connection.

11. A method of supplementing lighting on a vehicle, comprising:
providing an auxiliary lighting system comprising at least one light member and a bracket, the bracket having a base portion, a plurality of connection members extending from the base portion in a first direction, and a plurality of light attachment members extending from the base portion in a second direction;
releasably mounting the at least one light member to the base portion with the plurality of light attachment members;
releasably mounting the bracket to the vehicle with the plurality of connection members;
electrically connecting the at least one light member to a power source of the vehicle.

12. The method of claim 11, wherein the auxiliary lighting system further comprise a controller, the method comprising operating the controller to control the at least one light members between an OFF state and at least one ON state.

13. The method of claim 11, wherein the plurality of connection members provides a snap-fit connection of the bracket to the vehicle.

14. The method of claim 11, wherein the bracket is configured to releasably mount to a headlight housing or a tail light housing of the vehicle.

15. The method of claim 11, wherein the at least one light member generates white light and generates amber light.

16. The method of claim 11, further comprising operating the at least one light member to generate at least one of white light and amber light.
